(19) United States
(12) Patent Application Publication
(10) Pub. No.: US 2015/0380173 A1
(43) Pub. Date: Dec. 31, 2015

(54) BATTERY TYPE SUPER CAPACITOR ELECTRODE MATERIAL HAVING HIGH POWER DENSITY AND HIGH ENERGY DENSITY AND METHOD FOR PREPARING THE SAME

(71) Applicant: SOUTHWEST UNIVERSITY, Chongqing (CN)

(72) Inventors: Changming LI, Chongqing (CN); Pingping YANG, Chongqing (CN); Jiale XIE, Chongqing (CN)

(21) Appl. No.: 14/494,713

(22) Filed: Sep. 24, 2014

(30) Foreign Application Priority Data
Jun. 27, 2014 (CN) 201410300757.2

(51) Int. Cl. H01G 11/36; C25D 9/04; C25D 5/34; H01G 11/86

(52) U.S. Cl. CPC H01G 11/36; H01G 11/86; C25D 9/04; C25D 5/34

(57) ABSTRACT

A new battery type super capacitor electrode material having high power density and high energy density is provided. The electrode material is made from multi-layer of Bi₂S₃/CNT films and rGO films, wherein the layer number of Bi₂S₃/CNT films is same as the layer number of rGO films, and the Bi₂S₃/CNT films and rGO films are alternately stacked on top of each other. Further, a method of preparing an electrode material is provided. The methods includes coating Bi₂S₃/CNT and drying; depositing graphene oxide onto Bi₂S₃/CNT via electrochemical deposition; and, reducing graphene oxide to rGO by cyclic voltammetry to obtain a product. The capacitor electrode material has high energy density (460 Wh/kg), high power density (22802 W/kg) and specific capacitance (specific capacitance of 3568 F/g when current density is 22 A/g), and excellent cycling stability (remaining 90% of initial capacity after 1000 cycles).

### TECHNICAL FIELD

The present invention relates to capacitor parts field, and relates to capacitor electrode material. In particular, the present invention relates to battery type super capacitor electrode material having both high power density and high energy density.

### BACKGROUND

Super capacitor is also called electrochemical capacitor, which is an energy storage between conventional capacitor and battery and has high energy density. The super capacitor mainly relies on electrochemical reaction on the surface of electrode material and double-layer to store charges, and has advantages such as rapid charging and discharging, long service life, good stability, broad operation temperature, simple circuit, secure and reliable, and environmental friendly. Currently, super capacitor has been widely used commercially in, e.g., personal consumer electronics, electric vehicles, flexible electronic display and aerospace, etc. However, the existing super capacitor also has disadvantages, such as low charge storage capacity, and low power density. On the contrary, battery (e.g., lithium ion battery) has higher charge storage capacity, but has the shortcoming of low power density, which requires relatively long time to charge-discharge, and has certain security issues.

Thus, there is a need to develop a new super capacitor having both high energy density and high power density, to solve the issues experienced with the conventional energy storage device. No matter whether it is the battery or the super capacitor, the key to improve its energy density and power density is to choose proper electrode material. The components and micro nano structure of electrode material are decisive factors that affect energy conversion and storage.

Currently, the super capacitor mainly uses material with electrochemical activity such as metal oxides and conductive polymers as the electrode material. In addition, some metal hydroxides, metal sulfides and mixed metal oxides are also used as the electrode material of the super capacitor. Although these materials exhibit higher specific capacitance (i.e., charge storage capacity) and energy density, their power density is poor, and their energy density is rather low under high charge-discharge rate.

No prior art ever discloses a capacitor electrode material having both high power density and high energy density. Thus, there is a need to develop a novel battery type super capacitor electrode material, which allows the super capacitor to become an integrated environmental friendly energy storage device having both high energy density and high power density, to solve the issues experienced with the conventional energy storage device, and to improve existing commercially used energy storage device.

### SUMMARY

One objective of the present invention is to provide a new battery type super capacitor electrode material having high power density and high energy density.

In order to achieve the above objective, the present invention provides:

A new battery type super capacitor electrode material having high power density and high energy density, the electrode material is made from Bi₂S₃/CNT film and rGO film.

Preferably, the electrode material is made of multiple layers of Bi₂S₃/CNT films and rGO films, wherein the layer number of Bi₂S₃/CNT films is same as that of rGO films, and Bi₂S₃/CNT films and rGO films alternately stack on top of each other.

Yet, preferably, the layer number of Bi₂S₃/CNT films and rGO films is 2-10.

Yet, preferably, each Bi₂S₃/CNT film has a layer thickness of 50-200 nm, and each rGO film has a layer thickness of 50-200 nm.

The present invention further provides a method for preparing the super capacitor electrode material, including:

1) coating Bi₂S₃/CNT and drying;

2) conducting electrochemical deposition in a graphene oxide solution, to have graphene oxide adsorbed onto Bi₂S₃/CNT in step 1);

3) reducing graphene oxide adsorbed onto Bi₂S₃/CNT in step 2) to rGO in KCl solution by using cyclic voltammetry, and then taking out and drying;

4) repeating steps 1)-3) to obtain super capacitor electrode material.

Preferably, the method further includes a step of preparing Bi₂S₃/CNT before coating Bi₂S₃/CNT, comprising: first obtaining Bi(NO₃)₃.5H₂O, thioacetamide and CNT; then dissolving the above materials in water; and, finally placing the solution under 160-200° C. for reacting for 5-8 h, to obtain Bi₂S₃/CNT nano-compound.

Yet, preferably, when coating Bi₂S₃/CNT in step 1), Bi₂S₃/CNT is first dissolved in Nafion ethanol solution; and then Nafion ethanol solution of Bi₂S₃/CNT is dropped onto a surface of a substrate; wherein, Nafion ethanol solution of Bi₂S₃/CNT has a mass concentration of Bi₂S₃/CNT as 0.05-0.15 mg/mL, and Nafion and ethanol have a volume ratio of 1:10-1:50.

Yet, preferably, in step 2) of electrochemical deposition, Bi₂S₃/CNT obtained from step 1) is used as a working electrode, a platinum gauze electrode is a counter electrode, a saturated calomel electrode is a reference electrode, and graphene oxide solution is a electrolyte.

Yet, preferably, potentiostatic method is used to deposit graphene oxide, with a deposition potential as 2.0-3.0V, deposition time as 50-100 s, and concentration of graphene oxide as 0.3-0.8 mg/mL.

Yet, preferably, when reducing graphene oxide by using cyclic voltammetry in step 3), scanning speed is 40-60 mV/s, potential window is −1.1˜−0.2V, and scan cycle is 2-5 cycles.

### Technical Effects

The present invention can obtain a composite material having both high energy density (460 Wh/kg) and super high power density (22802 W/kg), extremely high specific capacitance (when charge-discharge current density is 22 A/g, specific capacitance is 3568 F/g) and excellent cyclical stability (remain 90% of initial capacity after 1000 cycles) by laminating cell capacitance material Bi₂S₃/CNT and capacitance material rGO, which can satisfy the needs of daily consumer electronic products, flexile instruments and large equipments, and has high academic and commercial values.

### BRIEF DESCRIPTION OF THE DRAWINGS

In order to clearly present the objectives of the present invention, the technical solutions and technical effects, description is given in connection with the drawings, wherein:

FIG. 1 is a scanning electron microscope (SEM) of a synthetic material; in which:

a-c show SEM of carbon nanotube (CNT) at low magnification;

d-f show SEM of Bi₂S₃ at low magnification;

g-i show SEM of Bi₂S₃/CNT nano-composite at low magnification obtained in accordance with Example 1.

FIG. 2 is a transmission electron microscope (TEM) of a synthetic material; in which:

a & b show TEM at low magnification and atomic resolution TEM of Bi₂S₃;

c & d show TEM of CNT;

e & f show TEM of Bi₂S₃/CNT nano-composite obtained in Example 1 at different magnification.

FIG. 3 is crystal structure and composition analysis chart of synthetic material; in which:

a shows X-ray diffraction (XRD) spectrum of CNT, Bi₂S₃ and Bi₂S₃/CNT nano-composite obtained in Example 1;

b shows element composition analysis (EDS) spectrum of CNT, Bi₂S₃ and Bi₂S₃/CNT nano-composite obtained in Example 1.

FIG. 4 shows texture analysis of synthetic material; in which:

a shows nitrogen adsorption-desorption isotherm curve of CNT, Bi₂S₃ and Bi₂S₃/CNT nano-composite obtained in Example 1;

b shows pore size distribution of CNT, Bi₂S₃ and Bi₂S₃/CNT nano-composite obtained in Example 1.

FIG. 5 shows three-electrode system electrochemical characterization diagram of CNT, Bi₂S₃ and Bi₂S₃/CNT nano-composite with various mass ratios; in which:

a shows cyclic voltammetry curve of CNT, Bi₂S₃ and Bi₂S₃/CNT nano-composite electrode with various mass ratios under 100 mV/s;

b shows specific capacitance of CNT, Bi₂S₃ and Bi₂S₃/CNT nano-composite electrode with various mass ratios under different scanning speed;

c shows charging-discharging curve of CNT, Bi₂S₃ and Bi₂S₃/CNT nano-composite electrode with different mass ratios under 10 A/g;

d shows electrochemical impedance curve of CNT, Bi₂S₃ and Bi₂S₃/CNT nano-composite electrode with different mass ratios.

FIG. 6 shows three-electrode system electrochemical characterization diagram of CNT, Bi₂S₃ and Bi₂S₃/CNT nano-composite obtained in Example 1; in which:

a shows cyclic voltammetry curve of CNT, Bi₂S₃ and Bi₂S₃/CNT nano-composite electrode obtained in Example 1 under 100 mV/s;

b shows unit specific capacitance of CNT, Bi₂S₃ and Bi₂S₃/CNT nano-composite electrode obtained in Example 1 under different current densities;

c shows electrochemical impedance curve of CNT, Bi₂S₃ and Bi₂S₃/CNT nano-composite electrode obtained in Example 1.

FIG. 7 shows two-electrode system electrochemical characterization diagram of Bi₂S₃/CNT nano-composite obtained in Example 1; in which:

a shows specific capacity retention diagram of Bi₂S₃/CNT nano-composite electrode obtained in Example 1 in charging-discharging 1000 cycles;

b shows electrochemical impedance diagram of Bi₂S₃/CNT nano-composite electrode obtained in Example 1 before and after charging-discharging 1000 cycles; in which the illustration (insert chart) shows an enlarged chart of electrochemical impedance diagram in high frequency region.

FIG. 8 shows a schematic diagram of preparing multi-layer (Bi₂S₃/CNT)/rGO nano-composite electrode;

FIG. 9 shows SEM of Bi₂S₃/CNT of Example 1 and multi-layer (Bi₂S₃/CNT)/rGO nano-composite electrode; in which:

a-c show SEM of Bi₂S₃/CNT nano-composite electrode under different magnification;

d shows SEM of multi-layer (Bi₂S₃/CNT)/rGO electrode; in which the illustration shows partial SEM enlarged view;

e shows SEM of cross-section of a multi-layer (Bi₂S₃/CNT)/rGO electrode;

f shows EDS spectrum of Bi₂S₃/CNT nano-composite electrode.

FIG. 10 shows three-electrode system electrochemical characterization diagram of various layered (Bi₂S₃/CNT)/rGO in Example 1-5 and 6-layered Bi₂S₃/CNT in comparative Example 5; in which:

a shows cyclic voltammetry curve of (Bi₂S₃/CNT)/rGO nano-composite electrode with one (1), two (2), four (4), six (6), and eight (8) layers under a scanning speed of 50 mV/s;

b shows charging-discharging curve of (Bi₂S₃/CNT)/rGO nano-composite electrode with one (1), two (2), four (4), six (6), and eight (8) layers under a current density of 22 A/g;

c shows cyclic voltammetry curve comparison of six (6)-layered (Bi₂S₃/CNT)/rGO nano-composite and six (6)-layered Bi₂S₃/CNT nano-composite electrode under a scanning speed of 50 mV/s;

d shows charging-discharging curve comparison of six (6)-layered (Bi₂S₃/CNT)/rGO nano-composite and six (6)-layered Bi₂S₃/CNT nano-composite electrode under a current density of 22 A/g.

FIG. 11 shows relationship of power density and energy density of multi-layered (Bi₂S₃/CNT)/rGO and performance comparison, in which:

a shows relationship of power density and energy density of (Bi₂S₃/CNT)/rGO nano-composite electrode with one (1), two (2), four (4), six (6), and eight (8) layers;

b shows comparison of power density and energy density between (Bi₂S₃/CNT)/rGO nano-composite electrode with one (1), two (2), four (4), six (6), and eight (8) layers and existing energy storage device.

### DETAILED DESCRIPTION

Detailed description will be given below to the preferred embodiments in connection with the drawings in detail. It is noted that ingredient parts means one by mass.

The following embodiments provide a new cell-type super capacitor electrode material having high power density and high energy density. The electrode material is made from Bi₂S₃/CNT film and rGO film, wherein the mass ratio of Bi₂S₃ and CNT in the Bi₂S₃/CNT film is 2:3˜2:5.

Preferably, the electrode material is made of multi-layer Bi₂S₃/CNT films and multi-layer rGO films, in which the layer number of Bi₂S₃/CNT films is same as that of rGO films, and Bi₂S₃/CNT films and rGO films alternately stack on top of each other.

Preferably, the layer number of Bi₂S₃/CNT films is 2-10, the layer number of rGO films is 2-10. Preferably, the layer number of Bi₂S₃/CNT films and rGO films are 6.

Preferably, each Bi₂S₃/CNT film has a layer thickness of 50-200 nm, and each rGO film has a layer thickness of 50-200 nm.

Preferably, a single composite layer (one layer of Bi₂S₃/CNT film and one layer of rGO film) of electrode material has a total thickness of 200-300 nm.

A method for preparing the new cell-type super capacitor electrode material is provided, comprising the following steps:

1) choosing a substrate (preferably a conductive material), and coating Bi₂S₃/CNT on the substrate and drying;

2) conducting electrochemical deposition in a graphene oxide solution, to have graphene oxide adsorbed onto Bi₂S₃/CNT in step 1);

3) reducing graphene oxide adsorbed onto Bi₂S₃/CNT in step 2) to rGO in saturated KCl solution by using cyclic voltammetry, and then taking out and drying;

4) repeating steps 1)-3) to obtain the electrode material (preferably repeating 1-10 times; in the process of repeating, in step 1, coating Bi₂S₃/CNT onto a surface of rGO reduced from the previous cycle).

Preferably, the method further includes a step of preparing Bi₂S₃/CNT before coating Bi₂S₃/CNT, comprising: first obtaining 8-12 parts of Bi(NO₃)₃.5H₂O, 28-32 parts of thioacetamide and 35 parts of carbon nanotube; then dissolving the materials in water; then placing the solution under 160-200° C. for reacting for 5-8 h, and finally cleaning and drying to obtain Bi₂S₃/CNT nano-composite.

Preferably, when coating Bi₂S₃/CNT in step 1), Bi₂S₃/CNT is first dissolved in Nafion ethanol solution; and then Nafion ethanol solution of Bi₂S₃/CNT is dropped onto a surface of the substrate; wherein, Nafion ethanol solution of Bi₂S₃/CNT has a mass concentration of Bi₂S₃/CNT as 0.05-0.15 mg/mL, and Nafion and ethanol have a volume ratio of 1:10-1:50.

Preferably, in step 2) of electrochemical deposition, Bi₂S₃/CNT obtained from step 1) is used as a working electrode, a platinum gauze electrode is a counter electrode, a saturated calomel electrode is a reference electrode, and graphene oxide solution is a electrolyte.

Preferably, potentiostatic method is used to deposit graphene oxide, with a deposition potential of 2.0-3.0V, deposition time of 50-100 s, and concentration of graphene oxide as 0.3-0.8 mg/mL.

Preferably, when reducing graphene oxide by using cyclic voltammetry in step 3), the scanning speed is 40-60 mV/s, potential window is −1.1˜−0.2V, and scan cycle is 2-5 cycles.

Preferably, the selected electrode in step 1) is glassy carbon electrode; when coating Bi₂S₃/CNT, the volume of Nafion ethanol solution of Bi₂S₃/CNT with a mass concentration of 0.05-0.15 mg/mL that drops onto the surface of glassy carbon electrode is 3-7 μL.

### Example 1

This Example provides a method for preparing a new cell-type super capacitor electrode material having high power density and high energy density, comprising the following steps:

1) obtaining exactly 0.485 g Bi(NO₃)₃.5H₂O, 1.5 g thioacetamide and 1.563 g carbon nanotube (CNT), to dissolve in 15 mL deionized water, and continuously stir for 5 min;

2) transferring suspension of step 1) to 20 mL high temperature reaction kettle, which is then placed in an air dry oven for reaction for 6 h under 180° C.;

3) upon the reaction kettle naturally cools down, washing Bi₂S₃/CNT (mass ratio of Bi₂S₃/CNT is 1:2) in the reaction kettle with deionized water and absolute ethyl alcohol for three times each, and then drying in the air dry oven under 60° C.;

4) preparing Bi₂S₃/CNT nano-composite to 1 mg/mL solution with 5% Nafion ethanol solution, with ultrasound for 5 min;

5) dropping 5 μL Bi₂S₃/CNT solution (1 mg/mL) onto the glassy carbon electrode with transfer liquid gun, and then allowing it to naturally dry;

6) using the glassy carbon electrode carried with Bi₂S₃/CNT nano-composite obtained in step 5) as the working electrode, a platinum gauze electrode as a counter electrode, a saturated calomel electrode as a reference electrode, and 0.5 mg/mL graphene oxide solution as electrolyte, to have potentiostatic deposition for 70 s under a potential of 2.5V;

7) changing the electrolyte to saturated KCl, scanning for three cycles at a scanning speed of 50 mV/s under a potential window of −1.1˜−0.2V to reduce graphene oxide to rGO, and then naturally drying to obtain an electrode with (Bi₂S₃/CNT)/rGO film;

8) repeating steps 5)-7) for five times with the electrode obtained in step 7), to obtain cell-type super capacitor electrode material with multi-layer (Bi₂S₃/CNT)/rGO.

In this Example, the glassy carbon electrode carried with Bi₂S₃/CNT nano-composite obtained in step 5) is used as the working electrode, the platinum gauze electrode is used as a counter electrode, the saturated calomel electrode is used as a reference electrode, and 0.5 mol/L NaClO₄ solution is used as electrolyte. Electrochemical workstation is used to measure cyclic voltammetry curve, charging-discharging curve, electrochemical impedance curve, and cyclical stability of Bi₂S₃/CNT nano-composite electrode. Further, the glassy carbon electrode grown with multi-layer (Bi₂S₃/CNT)/rGO in step 8) is used as the working electrode, the platinum gauze electrode is used as the counter electrode, the saturated calomel electrode is used as the reference electrode, and 0.5 M NaClO₄ solution is used as electrolyte. Electrochemical workstation is used to measure cyclic voltammetry curve, charging-discharging curve, electrochemical impedance curve, and cyclical stability of multi-layer (Bi₂S₃/CNT)/rGO cell-type super capacitor electrode material.

### Example 2

This Example differs from Example 1 in that: In step 8) of this Example, the number of repeating steps 5)-7) is zero.

### Example 3

This Example differs from Example 1 in that: In step 8) of this Example, the number of repeating steps 5)-7) is one (i.e., repeating steps 5)-7) once).

### Example 4

This Example differs from Example 1 in that: In step 8) of this Example, the number of repeating steps 5)-7) is three (i.e., three times).

### Example 5

This Example differs from Example 1 in that: In step 8) of this Example, the number of repeating steps 5)-7) is five (i.e., five times).

### Example 6

This Example differs from Example 1 in that: In step 8) of this Example, the number of repeating steps 5)-7) is seven (i.e., seven times).

### Comparative Example 1

This Example provides a method for preparing a new cell-type super capacitor electrode material having high power density and high energy density, comprising the following steps:

obtaining exactly 0.485 g Bi(NO₃)₃.5H₂O, 1.5 g thioacetamide and 3.126 g CNT, mixing Bi(NO₃)₃.5H₂O, thioacetamide and CNT, then dissolving in 15 ml doubly deionized water respectively, and continuously stirring for 5 min;

2) transferring suspension of step 1) to 20 mL reaction kettle, which is then placed in an air dry oven for reaction for 6 h under 180° C.;

3) upon the reaction kettle naturally cools down, washing Bi₂S₃ and Bi₂S₃/CNT composite (mass ratio of Bi₂S₃/CNT is 1:4) in the reaction kettle with double distilled water and absolute ethyl alcohol for three times each, and then drying in the air dry oven under 60° C.;

4) preparing Bi₂S₃/CNT nano-composite (mass ratio of Bi₂S₃/CNT is: 1:4) to 1 mg/mL solution with 5% Nafion ethanol solution, with ultrasound for 5 min;

5) dropping 5 microlitre of Bi₂S₃/CNT solution (1 mg/mL) onto the glassy carbon electrode with a transfer liquid gun, and then allowing it to naturally dry;

6) using the glassy carbon electrode carried with Bi₂S₃/CNT obtained in step 5) as the working electrode, a platinum gauze electrode as a counter electrode, a saturated calomel electrode as a reference electrode, and 0.5 mg/mL graphene oxide solution as electrolyte, to have potentiostatic deposition for 70 s under a potential of 2.5V;

7) using saturated KCl solution as electrolyte, and scanning for three cycles at a scanning speed of 50 mV/s under a potential window of −1.1˜−0.2V to reduce graphene oxide attached onto the surface of electrode in step 6) to rGO, and then naturally drying to obtain an electrode with (Bi₂S₃/CNT)/rGO film;

8) repeating steps 5)-7) for five times with the electrode obtained in step 7), to obtain cell-type super capacitor electrode material with six-layer (Bi₂S₃/CNT)/rGO (each single layer having one layer of Bi₂S₃/CNT and one layer of rGO).

In this Example, the glassy carbon electrode carried with Bi₂S₃/CNT nano-composite obtained in step 5) is used as the working electrode, the platinum gauze electrode is used as the counter electrode, the saturated calomel electrode is used as the reference electrode, and 0.5 mol/L NaClO₄ solution is used as electrolyte. Electrochemical workstation is used to measure cyclic voltammetry curve, charging-discharging curve, electrochemical impedance curve, and cyclical stability of Bi₂S₃/CNT nano-composite (electrode). Further, the multi-layer (Bi₂S₃/CNT)/rGO obtained in step 8) is used as the working electrode, the platinum gauze electrode is used as the counter electrode, the saturated calomel electrode is used as the reference electrode, and 0.5 M NaClO₄ solution is used as electrolyte. Electrochemical workstation is used to measure cyclic voltammetry curve, charging-discharging curve, electrochemical impedance curve, and cyclical stability of multi-layer (Bi₂S₃/CNT)/rGO cell-type super capacitor electrode material.

### Comparative Example 2

This Example differs from Comparative Example 1 in that: the carbon nanotube obtained is 0.781 g, and mass ratio of Bi₂S₃ and CNT in the obtained Bi₂S₃/CNT nano-composite is 1:1.

### Comparative Example 3

This Example differs from Comparative Example 1 in that: the carbon nanotube obtained is 0.391 g, and mass ratio of Bi₂S₃ and CNT in the obtained Bi₂S₃/CNT nano-composite is 2:1.

### Comparative Example 4

This Example differs from Comparative Example 1 in that: the carbon nanotube obtained is 0.195 g, and mass ratio of Bi₂S₃ and CNT in the obtained Bi₂S₃/CNT nano-composite is 4:1.

### Comparative Example 5

This Example differs from Comparative Example 1 in that: the carbon nanotube obtained is 0.000 g, and the obtained one is pure Bi₂S₃.

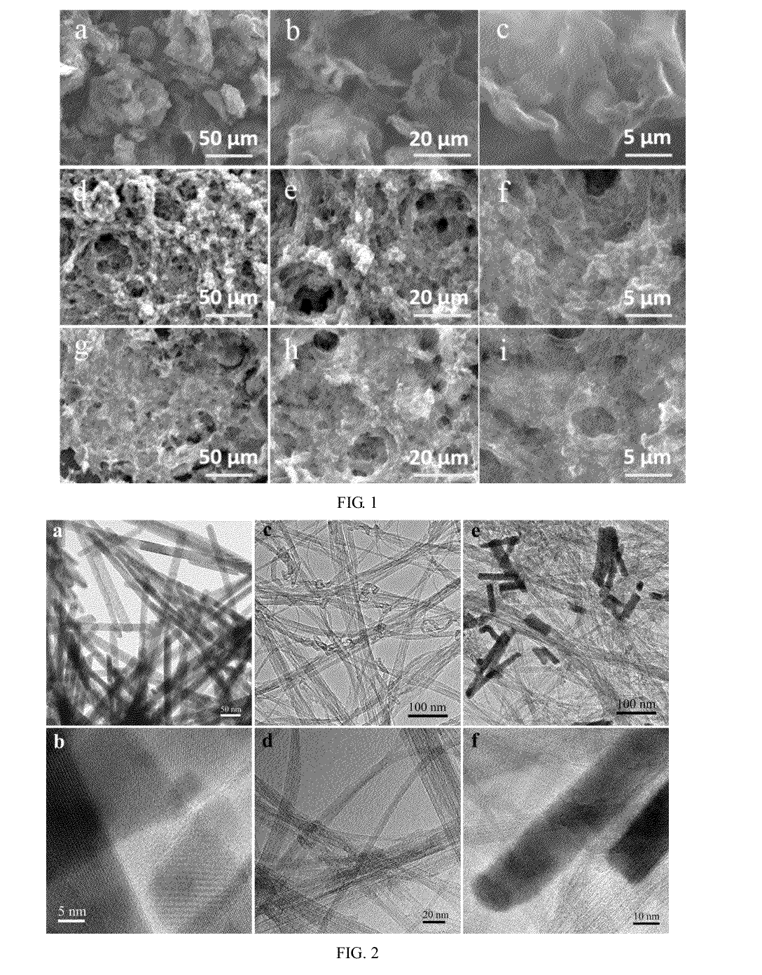

By characterizing materials and electrodes obtained from the Examples and Comparative Examples, the results are shown in FIGS. 1-11:

FIG. 1 is a scanning electron microscope (SEM) of a synthetic material; in which:

a-c show SEM of carbon nanotube (CNT) at low magnification, indicating that mono-CNT is easy to gather, with a large number of mesopores and micropores.

d-f show SEM of Bi₂S₃ at low magnification, indicating that mono-Bi₂S₃ is loose in structure, with a large number of macropores and mesopores.

g-i show SEM of Bi₂S₃/CNT nano-composite obtained from Example 1 at low magnification, indicating that combination of the two shows respective structural properties, with various sized pores, which facilitates contact and ion transport between electrode material and electrolyte.

FIG. 2 is a transmission electron microscope (TEM) of a synthetic material, in which:

a & b show TEM of Bi₂S₃ at low magnification and atomic resolution TEM of Bi₂S₃, indicating that mono-Bi₂S₃ is a nanorod having a diameter of about 20-35 nm, and that the atomic resolution proves the synthesized Bi₂S₃ is monocrystal.

c & d show TEM of CNT, indicating that mono-CNT is easy to form net structure composed of bundled CNT, which facilitates electron transport therein.

e & f show TEM of Bi₂S₃/CNT nano-composite obtained from Example 1 at different magnification, indicating that combination of the two forms a structure of CNT conductive web covering Bi₂S₃ nanorod, which facilitates enhancing electrochemical activity.

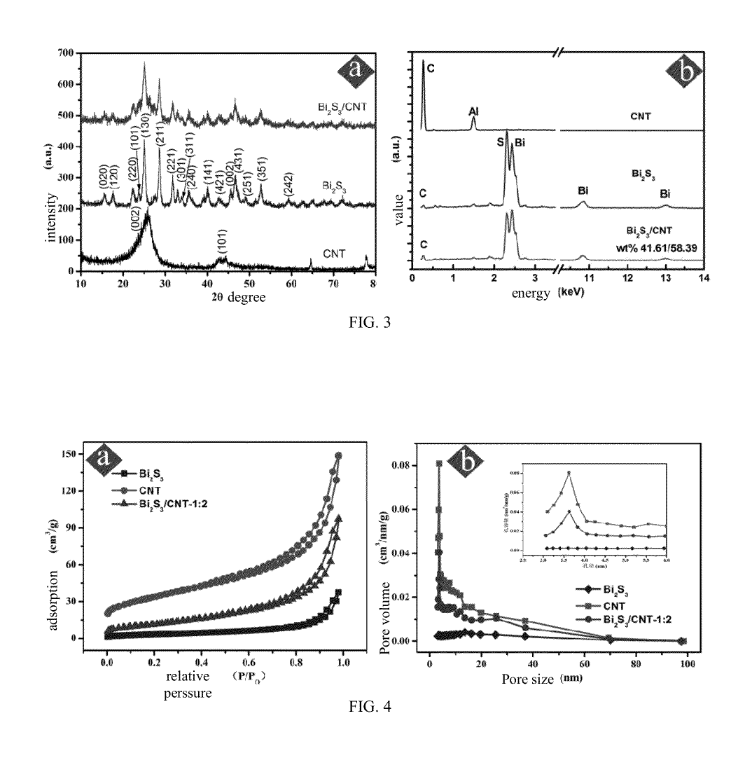

FIG. 3 is crystal structure and composition analysis chart of the synthetic material, in which:

a shows X-ray diffraction (XRD) spectrum of CNT, Bi₂S₃ and Bi₂S₃/CNT nano-composite obtained in Example 1, indicating that the synthesized Bi₂S₃ has a typical structure of monocrystal bismuthinite, while Bi₂S₃/CNT nano-composite combines both properties, which indicates that the two are only combined in structure and chemical reaction is occurred during the synthesis process of the two.

b shows element composition analysis (EDS) spectrum of CNT, Bi₂S₃ and Bi₂S₃/CNT nano-composite obtained in Example 1, indicating that the synthesized material does not contain other impurity elements (A1 is the main element of the test sample table), and the ratio of Bi₂S₃ and CNT is 41.61:58.39 in Bi₂S₃/CNT nano-composite.

FIG. 4 shows texture property analysis of synthetic material, in which:

a shows nitrogen adsorption-desorption isotherm curve of CNT, Bi₂S₃ and Bi₂S₃/CNT nano-composite obtained in Example 1, indicating that CNT and Bi₂S₃/CNT have typical mesoporous characteristics, while Bi₂S₃ only has some pores formed among nanorods.

b shows pore size distribution of CNT, Bi₂S₃ and Bi₂S₃/CNT nano-composite obtained in Example 1, indicating that CNT has micropores and mesopores and large pore volume, while Bi₂S₃ does not have obvious pore distribution; Bi₂S₃/CNT nano-composite combines the properties of Bi₂S₃ and CNT, exhibiting a broad pore distribution and relatively large pore volume (i.e., surface area), which facilitates ion transport in the electrolyte.

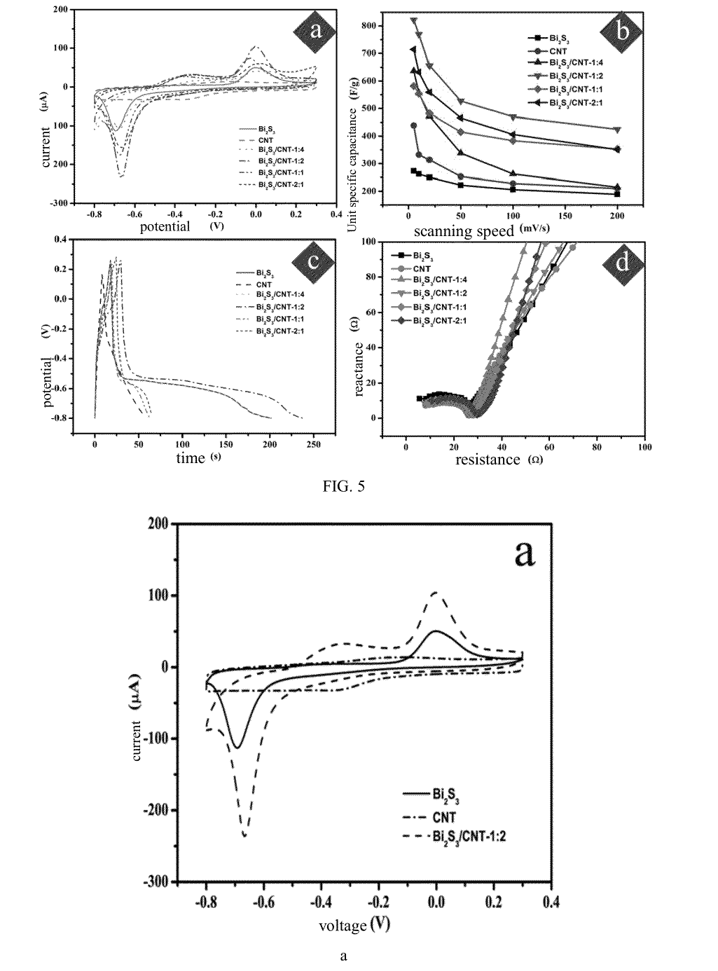

FIG. 5 shows three-electrode system electrochemical characterization diagram of CNT, Bi₂S₃ and Bi₂S₃/CNT nano-composite with various mass ratios, in which:

a shows cyclic voltammetry curve of CNT, Bi₂S₃ and Bi₂S₃/CNT nano-composite electrode with various mass ratios under 100 mV/s. It can be seen that Bi₂S₃/CNT with mass ratio of 1:2 has the highest peak current density, i.e., highest electrochemical activity.

b shows specific capacitance of CNT, Bi₂S₃ and Bi₂S₃/CNT nano-composite electrode with various mass ratios under different scanning speed, indicating that Bi₂S₃/CNT with mass ratio of 1:2 is most preferred.

c shows charging-discharging curve of CNT, Bi₂S₃ and Bi₂S₃/CNT nano-composite electrode with different mass ratios under 10 A/g. It can be seen that Bi₂S₃ and Bi₂S₃/CNT exhibit discharge plateau, which is a typical characteristic of cell-type material. Further, it also shows that Bi₂S₃/CNT with mass ratio of 1:2 is most preferred.

d shows electrochemical impedance curve of CNT, Bi₂S₃ and Bi₂S₃/CNT nano-composite electrode with different mass ratio, indicating that Bi₂S₃ and CNT help to improve ion diffusion performance of electrode material.

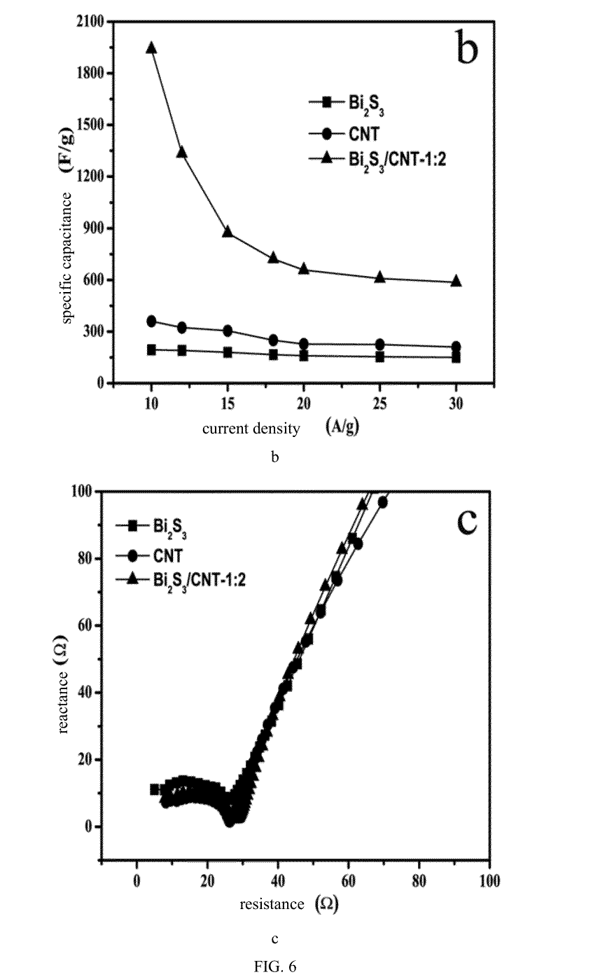

FIG. 6 shows three-electrode system electrochemical characterization diagram of Bi₂S₃, CNT and Bi₂S₃/CNT nano-composite obtained in Example 1, in which:

a shows cyclic voltammetry curve of CNT, Bi₂S₃ and Bi₂S₃/CNT nano-composite electrode obtained in Example 1 under 100 mV/s, indicating that Bi₂S₃/CNT nano-composite has both characteristics, which improves double-layer capacitance and pseudo capacitance.

b shows specific capacitance of CNT, Bi₂S₃ and Bi₂S₃/CNT nano-composite electrode obtained in Example 1 under different current densities, in which Bi₂S₃/CNT nano-composite exhibits good magnification charge-discharge performance and high specific capacitance, indicating that Bi₂S₃ and CNT have good synergetic effect.

c shows electrochemical impedance curve of CNT, Bi₂S₃ and Bi₂S₃/CNT nano-composite electrode obtained in Example 1, in which Bi₂S₃/CNT nano-composite exhibits relative low electrochemical reaction resistance, indicating that the composite has good electrochemical activity.

FIG. 7 shows two-electrode system electrochemical characterization diagram of Bi₂S₃/CNT nano-composite obtained in Example 1, in which:

a shows specific capacity retention diagram of Bi₂S₃/CNT nano-composite electrode obtained in Example 1 in charging-discharging 1000 cycles. After 1000 cycles, 90% capacitance is still remained. This indicates that Bi₂S₃/CNT nano-composite has very good cyclical stability.

b shows electrochemical impedance diagram of Bi₂S₃/CNT nano-composite electrode obtained in Example 1 before and after charging-discharging 1000 cycles; in which the illustration (insert chart) shows an enlarged view of electrochemical impedance diagram in high frequency region. The electrochemical impedance spectrum does not change significantly before and after 1000 cycles of charging-discharging. This further indicates that Bi₂S₃/CNT nano-composite has very good cycling stability.

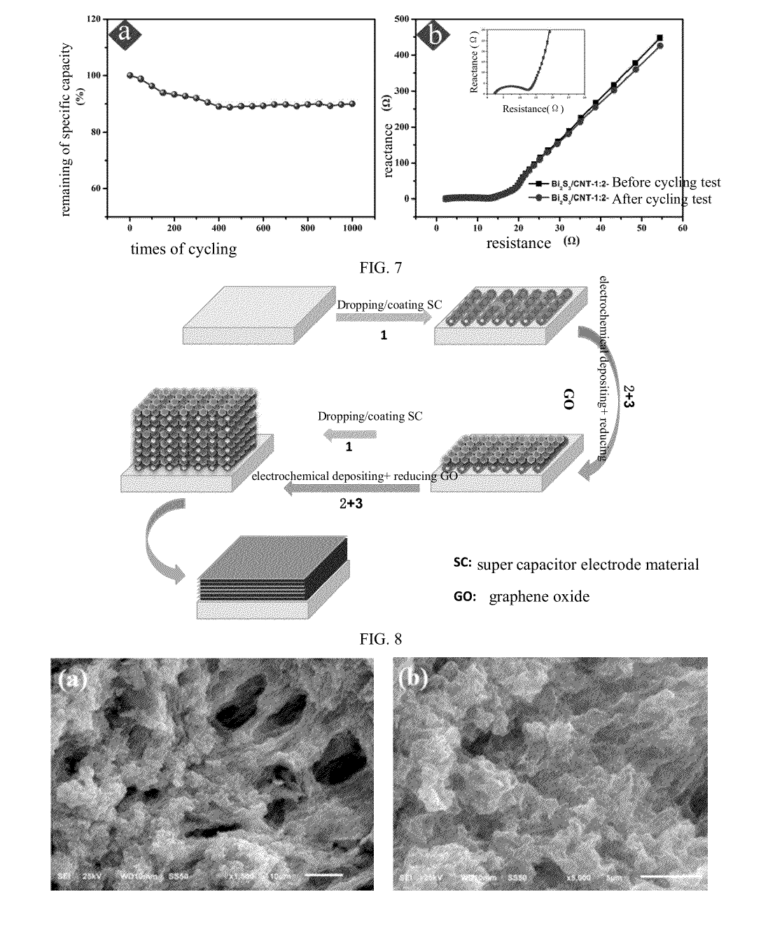

FIG. 8 shows a schematic diagram of preparing multi-layer (Bi₂S₃/CNT)/rGO nano-composite electrode, wherein:

1) a substrate (preferably conductive material) is first selected, and Bi₂S₃/CNT is coated on the substrate and then is dried;

2) electrochemical deposition is performed in graphene oxide solution, to have graphene oxide adsorbed onto Bi₂S₃/CNT from step 1);

3) in saturated KCl solution, cyclic voltammetry is used to reduce graphene oxide adsorbed onto Bi₂S₃/CNT in step 2) to rGO, which is then taken out for drying;

4) a product is obtained by repeating steps 1)-3) for a number of times (preferably repeating for 1-10 times; in the process of repeating, in step 1, Bi₂S₃/CNT is coated onto the surface of reduced rGO obtained from the previous cycle).

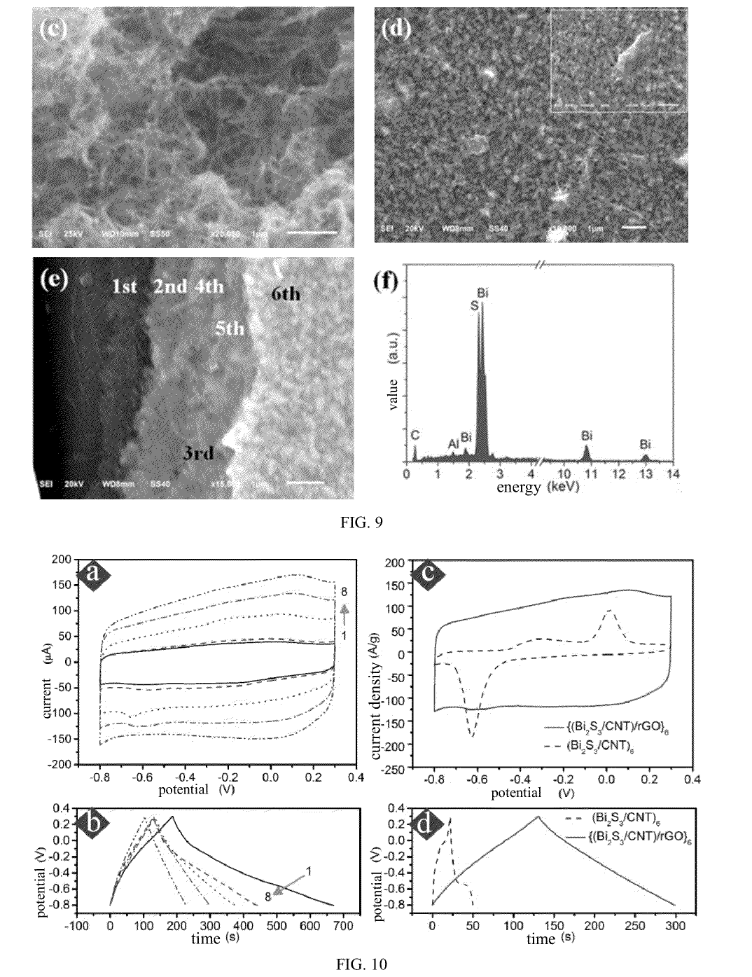

FIG. 9 shows SEM of Bi₂S₃/CNT of Example 1 and multi-layer (Bi₂S₃/CNT)/rGO nano-composite electrode, in which:

a shows SEM of Bi₂S₃/CNT nano-composite electrode, and the illustration (insert view) is its partial SEM enlarged view. The electrode surface morphology is uniform in micron scale. CNT and rGO are vague (barely visible). In the illustration, pleats of rGO can be seen clearly.

b shows SEM of cross-section of a multi-layer (Bi₂S₃/CNT)/rGO electrode, in which each layer can be seen clearly, and the layer number of each layer is marked in the drawing.

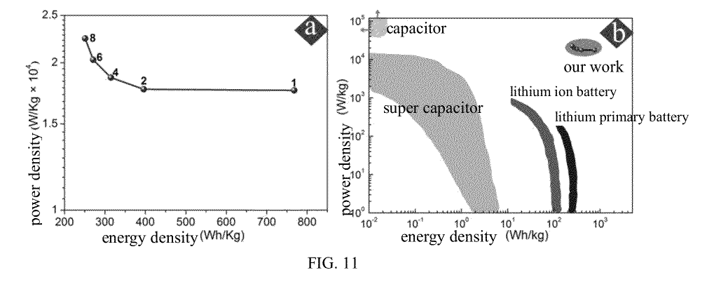

FIG. 10 shows three-electrode system electrochemical characterization diagram of various layered (Bi₂S₃/CNT)/rGO in Example 1-5 and 6-layered Bi₂S₃/CNT in comparative Example 5, in which:

a shows cyclic voltammetry curve of (Bi₂S₃/CNT)/rGO nano-composite electrode with one (1), two (2), four (4), six (6), and eight (8) layers under a scanning speed of 50 mV/s. It can be seen that with the number of layers increases, the current increases. This indicates that the mass of electrode and inserted layers of rGO may increase area of electrode material.

b shows charging-discharging curve of (Bi₂S₃/CNT)/rGO nano-composite electrode with one (1), two (2), four (4), six (6), and eight (8) layers under a current density of 22 A/g. With the number of layers increases, the discharge plateau of discharging curve of the electrode gradually decreases. When the layer number is six (6), a typical double-layer capacitance characteristic is shown.

c shows cyclic voltammetry curve comparison of six (6)-layered (Bi₂S₃/CNT)/rGO nano-composite and six (6)-layered Bi₂S₃/CNT nano-composite electrode under a scanning speed of 50 mV/s. Upon rGO is inserted, (Bi₂S₃/CNT)/rGO electrode exhibits rectangle-shaped cyclic voltammetry curve, i.e., typical capacitive characteristic.

d shows charging-discharging curve comparison of six (6)-layered (Bi₂S₃/CNT)/rGO nano-composite and six (6)-layered Bi₂S₃/CNT nano-composite electrode under a current density of 22 A/g, indicating that insertion of rGO layer(s) can perfectly convert the electrode material from battery type to capacitance type.

FIG. 11 shows relationship of power density and energy density of multi-layered (Bi₂S₃/CNT)/rGO and performance comparison, in which:

a shows relationship of power density and energy density of (Bi₂S₃/CNT)/rGO nano-composite electrode with one (1), two (2), four (4), six (6), and eight (8) layers. It can be seen that with the number of layers increases, the energy density gradually decreases, while the power density gradually increases, i.e., electrode converting from cell type to capacitance type.

b shows comparison of power density and energy density between (Bi₂S₃/CNT)/rGO nano-composite electrode with one (1), two (2), four (4), six (6), and eight (8) layers and existing energy storage device. It can be clearly seen that (Bi₂S₃/CNT)/rGO nano-composite electrode has very high energy density and power density, superior to existing super capacitor and lithium ion battery (lithium primary battery).

The above measurements and results show that, in the embodiments, the Bi₂S₃/CNT nano-composite prepared by hydro-thermal method is a good battery type electrode material. With a number of times of electrochemical deposition and electrochemical reduction, a multi-layered (Bi₂S₃/CNT)/rGO nano-composite which is prepared based on Bi₂S₃/CNT film is converted to capacitive material, which has very high power density, energy density, specific capacitance, and excellent cycling stability (in the three-electrode system, using 0.5 mol/L Na₂ClO₄ solution as electrolyte, the new battery type super capacitor electrode material has a specific capacitance of 3568 F/g, energy density up to 460 Wh/kg, power density up to 22802 W/kg, and up to 90% of initial capacity after 1000 cycles). In the Comparative Examples, the specific capacitance, power density and energy density of various materials are relatively low.

It shall be noted that, although the experiments show that the preferred mass ratio of Bi₂S₃/CNT nano-composite is 1:2, the most preferred number of layers of (Bi₂S₃/CNT)/rGO nano-composite is six (6); other mass ratio and number of layers can also achieve good technical results.

In the present invention, the preparation and processing parameters of Bi₂S₃/CNT nano-composite can be parameters for processing other similar battery type materials, and the preparation parameters can be adjusted accordingly in a certain range. The preparing and processing method of multi-layer (Bi₂S₃/CNT)/rGO nano-composite can also be used for processing other capacitor materials having similar structure. The preparing method is not limited to electrochemical deposition, and the materials used are not limited to GO. Other capacitive film materials having good conductivity can also be used.

The above preferred embodiments are only for illustrating the present invention, and not for limiting purpose. Although detailed description has been in connection with above preferred embodiments, it is understood that people skilled in the art can make various modification thereto, without departing from the spirit and scope of the present invention.

1. A cell-type super capacitor electrode material having high power density and high energy density, wherein: the electrode material is made from Bi₂S₃/CNT films and rGO films.

2. A cell-type super capacitor electrode material according to claim 1, wherein: the electrode material is made of a plurality of layers of Bi₂S₃/CNT films and a plurality of layers of rGO films, in which the layer number of Bi₂S₃/CNT films is same as the layer number of rGO films, and the Bi₂S₃/CNT films and the rGO films alternately stack on top of each other.

3. A cell-type super capacitor electrode material according to claim 2, wherein: the Bi₂S₃/CNT films and rGO films have 2-10 layers.

4. A cell-type super capacitor electrode material according to claim 2, wherein: each Bi₂S₃/CNT film has a layer thickness of 50-200 nm, and each rGO film has a layer thickness of 50-200 nm.

5. A method for preparing a cell-type super capacitor electrode material of claim 1, wherein: the method comprises the following steps:
1) coating Bi₂S₃/CNT and drying;
2) conducting electrochemical deposition in a graphene oxide solution, to allow graphene oxide to be adsorbed onto Bi₂S₃/CNT of step 1);
3) in a KCl solution, using cyclic voltammetry to reduce graphene oxide adsorbed onto Bi₂S₃/CNT in step 2) to rGO, which is then taken out and dried;
4) repeating steps 1)-3) to obtain the super capacitor electrode material.

6. A method for preparing a cell-type super capacitor electrode material according to claim 5, wherein: the method further includes a step of preparing Bi₂S₃/CNT before coating Bi₂S₃/CNT, including: taking Bi(NO₃)₃.5H₂O, thioacetamide and CNT; dissolving Bi(NO₃)₃.5H₂O, thioacetamide and CNT in water to obtain a solution; and, placing the solution under 160-200° C. for reaction for 5-8 hours, to obtain Bi₂S₃/CNT nano-composite.

7. A method for preparing a cell-type super capacitor electrode material according to claim 5, wherein: when coating Bi₂S₃/CNT in step 1), Bi₂S₃/CNT is first dissolved in Nafion ethanol solution; then, dropping Nafion ethanol solution containing Bi₂S₃/CNT onto a surface of a substrate; in which mass concentration of Bi₂S₃/CNT in Nafion ethanol solution containing Bi₂S₃/CNT is 0.05-0.15 mg/mL, and volume ratio of Nafion and ethanol is 1:10-1:50.

8. A method for preparing a cell-type super capacitor electrode material according to claim 5, wherein: when conducting electrochemical deposition in step 2), the Bi₂S₃/CNT obtained in step 1) is used as a working electrode, a platinum gauze electrode is used as a counter electrode, a saturated calomel electrode is used as a reference electrode, and graphene oxide solution is an electrolyte.

9. A method for preparing a cell-type super capacitor electrode material according to claim 8, wherein: using potentiostatic method to deposit graphene oxide, with a deposition potential as 2.0-3.0V, a deposition time as 50-100 s, and concentration of graphene oxide as 0.3-0.8 mg/mL.

10. A method for preparing a cell-type super capacitor electrode material according to claim 5, wherein: when using cyclic voltammetry to reducing graphene oxide in step 3), a scanning speed is 40-60 mV/s, a potential window is −1.1˜−0.2V, and scanning cycle is 2-5 cycles.
